(19) United States
(12) Patent Application Publication
(10) Pub. No.: US 2002/0012738 A1
(43) Pub. Date: Jan. 31, 2002

(54) Low calorie fat compositions

(76) Inventor: Damodara Gopal, Mayfield HTS, OH (US)

Correspondence Address: Senniger, Powers, Leavitt & Roedel, One Metropolitan Square, 16th Floor, St. Louis, MO, 63102, US

(21) Appl. No.: 09/753,299

(22) Filed: Dec. 29, 2000

Related U.S. Application Data
(60) Provisional application No. 60/174,945, filed on Jan. 7, 2000.

(51) Int. Cl. A23D 9/00

(52) U.S. Cl. 426/601

(57) ABSTRACT

By this invention, low calorie fat compositions comprising the use of wax esters are provided. Of particular interest is the use of wax ester compositions having a long chain hydrocarbon and a medium chain hydrocarbon. Preferably, the long chain hydrocarbon group is a saturated long chain hydrocarbon. The wax ester compositions find use as low calorie fat ingredients in food compositions. The low calorie fat compositions of the present invention demonstrate a caloric value of less than 6 kcal/g. Such low calorie fat compositions find use in the preparation of food compositions wherein at least a portion of the fat ingredients have been replaced with a wax ester composition of the present invention.

### CROSS REFERENCE TO RELATED APPLICATIONS

This specification claims the benefit of U.S. Ser. No. 60/174,945, filed Jan. 7, 2000, which disclosure is incorporated herein by reference.

### INTRODUCTION

1. Field of the Invention

The present invention relates to low calorie fat compositions. More specifically, the present invention relates to wax ester compositions for use in low calorie fat compositions, and in particular, the use of such wax ester compositions in low calorie fat-containing food compositions.

2. BACKGROUND

One of the most common metabolic conditions today is obesity. Of the various reasons for the condition, ingestion of a greater number of calories than are needed is a primary factor. Fat is the most concentrated form of energy in the diet, with each gram of fat providing approximately 9 calories. In the typical diet, fat comprises about 40% of the total calories ingested. Fats, however, are an important part of food compositions as they provide mouth feel, instill flavor, and are required for certain vitamin absorption.

Recently, research efforts have focused on the synthesis of low calorie fats (U.S. Pat. No. 3,579,548; Hamm, (1984) J. Food Sci. 49:419-428; EP 0910955; U.S. Pat. Nos. 3,637,774, and 4,582,715), and several products are currently on the market.

Some of the main problems in fat replacement are to maintain the desirable properties of the edible fat. The most common non-digestible fats are associated with many undesirable side effects like cramping, vitamin sequestration, and undesired passive oil loss.

There is a need in the art for low calorie fat compounds which do not have such side effects, and are readily attainable.

### Relevant Literature

Wax ester compositions are disclosed in EP 0 910 955 A2.

### SUMMARY OF THE INVENTION

By this invention, methods for reducing the caloric value of a wax ester as well as low calorie fat compositions are provided which are useful in the preparation of food compositions.

A first aspect of the present invention provides a low calorie fat composition comprising a wax ester having at least one long chain hydrocarbon group and at least one medium chain hydrocarbon group. The long chain hydrocarbon group is preferably selected from the group consisting of a fatty acid and a fatty alcohol. More preferably, the long chain hydrocarbon group is a saturated long chain hydrocarbon selected from the group consisting of a fatty acid and a fatty alcohol. The medium chain hydrocarbon groups for use in the compositions of the present invention include those that are less than about 12 carbons.

In another aspect of the present invention, low calorie fat compositions of particular interest in the present invention comprise a wax ester having the formula:

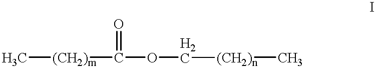

wherein m is 14 or greater, and n is less than 10.

Also provided in the present invention are wax ester compositions comprising a long chain fatty alcohol and a fatty acid having the formula:

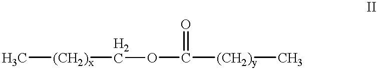

The long chain alcohol is preferably saturated and has 16 or more carbons (x≧14), the fatty acid is preferably a medium chain fatty acid and contains less than about 12 carbons preferably has 2 to 10 carbons (y≦8).

These wax ester compositions can be used either alone or in combination with vegetable oils. Furthermore, the compositions can be hydrolyzed to the high melting and poorly absorbed long chain saturated acids or alcohols.

The wax ester compositions of the present invention particularly find use in low calorie food compositions.

### DESCRIPTION OF THE SPECIFIC EMBODIMENTS

In accordance with the subject invention, methods and compositions related to low calorie fats are provided. In particular, the present invention provides wax ester compositions and methods of use as low calorie fats in food compositions.

A first aspect of the present invention provides wax esters compositions comprising at least one long chain hydrocarbon group. The hydrocarbons include long chain fatty acids and long chain fatty alcohols. Preferably, the long chain hydrocarbon groups are saturated.

More particularly, the wax esters of the present invention comprise at least a saturated long chain fatty hydrocarbon group having at least 14 carbons long, preferably the carbon group has between about 14 and about 30 carbons, more preferably, between about 14 and about 28 carbons, and most preferably between about 14 and about 24 carbons.

The wax esters compositions of the present invention also include a medium chain hydrocarbon group, including medium fatty alcohols and medium chain fatty acids. As used herein, medium chain refers to carbon chain lengths of less than 12 carbons, preferably the carbon chain contains between 2 and 12 carbons.

In general, the wax ester compositions comprise a fatty acid esterified with a fatty alcohol. Such compositions find use in a wide variety of food applications as a low calorie fat. The wax esters for use in the low calorie food compositions generally comprise less than about 50 carbons, preferably less than about 40 carbons, and most preferably less than about 36 carbons.

The individual fatty acids and fatty alcohols for use in the compositions of the present invention have melting points in the range of about 40° C. to about 100° C., preferably, in the range of about 50° C. to about 90° C. The wax ester containing the fatty acids and fatty alcohols have a combined melting temperature in the range of about 15° C. to about 45° C.

Thus, a first embodiment of the present invention provides a wax ester composition having the formula:

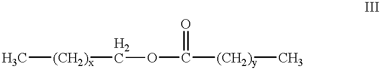

The fatty acids for use in the wax ester compositions of formula III comprise saturated fatty acids. Preferably, the saturated fatty acids are long chain fatty acids, more preferably, the fatty acids contain 16 or greater carbons (x≧14 in formula III), most preferably, the long chain fatty acids contain 16-28 carbons, and most preferably 16-24 carbons.

Generally, the alcohols used in the preparation of the wax ester compositions of formula III are medium chain alcohols. Preferably, the alcohols for use in the present invention are between about 2 and about 14 carbons, more preferably between about 2 and about 12 carbons, more especially preferred between about 2 and about 10 carbons.

Another aspect of the present invention provides wax ester compositions having the formula:

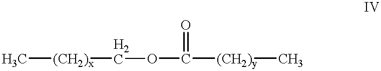

Preferably, the alcohol for use in the wax ester of formula IV is a long chain alcohol. The long chain alcohol is preferably saturated and has 16 or more carbons (x≧14), more preferably the long chain alcohol has between about 16 and about 30 carbons, and most preferably between about 16 and about 24 carbons. Preferably the fatty acid for use in the wax ester compositions of formula IV include those of less than about 12 carbons, and more preferably the fatty acid has about 2 to about 10 carbons.

The wax ester compositions of the present invention provide a low calorie fat composition. The wax ester compositions of the present invention preferably provide less than about 6 kcal/g, more preferably less than 5.7 kcal/g, especially preferred less than about 5.2 kcal/g, most especially preferred, less than about 4.7 kcal/g.

The wax ester compositions for use as low calorie fat compositions of the present invention can be obtained from any source, including natural and synthetic sources. Also included as a source of the wax esters are genetically engineered sources, such as yeasts, bacterial, plants and the like. Methods for the production of wax esters in a genetically modified source are described for example in PCT Publication WO 98/55633, the entirety of which is incorporated herein by reference.

Thus, the wax ester compositions of the present invention provide low calorie fat compositions which find use in the preparation of a wide variety of food applications.

The low calorie fat compositions of the present invention can be used as a partial or total replacement for normal fats in any fat-containing food product comprising fat and nonfat ingredients to provide reduced calorie benefits. In order to obtain a significant reduction in calories, at least about 5%, and preferably at least about 20%, of the total fat in the food product comprises the low calorie fat composition of the present invention. Alternatively, 100% replacement of normal fats with the wax ester compositions of the present invention provides a highly desirable food composition. In addition, the wax ester compositions can be blended with other low calorie fats, fat replacers or fat mimetics.

Thus, the wax ester compositions of the present invention can be used in a variety of applications. Of particular interest in the present invention is the use of the wax ester compositions in various food applications. Of most particular interest is the use in low calorie food applications.

Thus, the wax ester compositions of the present invention find use in the preparation of foods, food products, processed foods, food ingredients, food additive compositions, or dietary supplements that contain oils and/or fats. Examples of such uses include but are not limited to margarines, butters, shortenings, dressings, spreads, frying oils, mayonnaises, and vitamin/mineral supplements. Additional examples include, but are not limited to toppings, dairy products such as cheese and processed cheese, processed meat and meat mimetics, pastas, cereals, sauces, desserts including frozen and shelf stable desserts, dips, chips, baked goods, pastries, cookies, snack bars, confections, chocolates, beverages, unextracted seed, and unextracted seed that has been ground, cracked, milled, rolled, extruded, pelleted, defatted, dehydrated, or otherwise processed, but which still contains the oils, etc., disclosed herein.

The invention now being generally described, it will be more readily understood by reference to the following examples which are included for purposes of illustration only and are not intended to limit the present invention.

### EXAMPLES

Unless otherwise indicated, all parts and percentages are by weight.

### Example 1: Preparation of Arachidyl Caprylate

The melting points for various fatty alcohols and fatty acids is provided in Table 1.

TABLE 1

| Alcohols | | Acids | |
|---|---|---|---|
| Name | M. P. | Name | M. P. |
| 1-Hexadecanol | 50° C. | Palmitic acid | 63-64° C. |
| 1-Heptadecanol | 54° C. | Heptadecanoic acid | 62-63° C. |
| 1-Octadecanol | 59.5° C. | Stearic acid | 69.7° C. |
| 1-Nonadecanol | 62-63° C. | Nondecanoic acid | 68.7° C. |
| 1-Icosanol | 72.5-73° C. | Icosanoic acid | 72.5-73° C. |
| 1-Docosanol | 72.5° C. | Behenic acid | 81-82° C. |
| 1-Tricosanol | 73.5-74.5° C. | Tricosanoic acid | 79.1° C. |
| 1-Tetracosanol | 77-79° C. | Tetracosanoic acid | 87.5-88° C. |
| 1 -Hexacosanol | 80° C. | Hexacosanoic acid | 88-89° C. |

In this example, Arachidyl caprylate, an ester from saturated C20 alcohol and a medium chain acid was prepared by base catalyzed ester exchange reaction.

Arachidyl alcohol (59.6 g, 0.2 mole) and methyl caprylate (63.2 g, 0.4 mole) were heated to 90° C. and sodium methoxide (0.25 g) was added. The mixture was stirred for four hours under low pressure (25 mm Hg). During the reaction nitrogen (or argon) is continuously passed through the reaction mixture to distill the methanol produced in the reaction. The reaction mixture was filtered through filtrol and the product was washed with warm brine solution. The product was dried with (MgSO₄) and filtered. The excess starting material and residual methanol were removed from the product by short-column distillation and deodorization.

### Example 2: Preparation of Capryl Eicosanoate

Methyl eicosanoate (65.3 g, 0.2 mole) and octyl alcohol (52 g, 0.4 mole) were heated to 90° C. and sodium methoxide was introduced. Using the above procedure capryl eicosanoate was isolated and purified.

### Example 3: Preparation of Lauryl Canolate (Oleate)

Methyl esters of fatty acid from high oleic canola oil was reacted with lauryl alcohol in the presence of sodium methoxide at 90° C. The product was isolated as in example 1 to get the final product.

### Example 4: Hydrolysis by Pancreatic Lipase

The digestibility of the wax esters derived from long chain and medium chain combinations (III and IV) of the present invention were done to compare with triolein and wax esters derived from long chain acids and long chain alcohols. The in-vitro assays were done using two emulsion systems as in the following procedure.

### Organic Solvent

Each digest was carried out with 300 mg of the fat/fat substitute, 9 ml of the ^{t}amyl alcohol, 0.5 ml of Bis-Tris propane buffer (10 mM, pH 7.8) and 0.5 ml of porcine lipase (20 mg/mi). The reaction was incubated at 30° C. and the reaction stopped by adding 1 ml aliquots to 3 ml of isopropanol/heptane/sulfuric acid (40/10/1). The product was extracted with heptane and analyzed by GC and GC-MS at 360° C.

### Aqueous Emulsion

A mixture of 300 mg of the fat/fat substitute, 4 ml of Bis-Tris propane buffer (10 mM, pH 7.8), 5 ml of hydroxyproylmethylcellulose (HMPC, 25 g/ml), 0.5 ml of sodium cholate (0.1 M) were sonicated to disperse the fats and incubated at 30° C. Porcine lipase (0.5 ml, 20 mg/ml) was added. The analysis of the reaction was carried out as in the above organic solution assay. The results of the analysis are provided below in Table 2.

TABLE 2

| | | Organic | | Aqueous | |
|---|---|---|---|---|---|
| | | Solution Assay | | Emulsion Assay | |
| No. | Name | 24 hr | 48 h | 24 hr | 48 h |
| 1 | Triolein | 69.2 | | 93.3 | |
| 2 | Arachidyl caprylate | 7.6 | | 14.7 | |
| 3 | Arachidyl caproate | 2.2 | | 4.0 | |
| 4 | Hexyl arachidate | 5.4 | | 11.7 | |
| 5 | Jojoba oil | 3.4 | | 0.0 | |
| 6 | Saturated Jojoba oil | 0.0 | | 0.0 | |

### Example 5: Caloric Availability

Caloric availability of the compounds are evaluated by the two week feeding study of young male Sprague-Dawley rats weighing approximately 50 to 60 gm as described by Finley, et al. ((1994) J. Agric. Food Chem. 42:489-494. A five group of rats were studied for each compound (0%, 7%, 11%, 15% and 19% fat) using AJN-76 diet. Weight gains are monitored at days 0, 3, 7, 10 and 14.

Caloric availability of arachidyl caprylate was estimated to be 5.2±0.5 kcal/g based on the weight gain in the two week feeding study. Wax esters produced from oleic acid and lauryl alcohol was estimated to have a caloric value of about 8.2±0.5 kcal/g based on weight gain during the two week feeding study.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claim.

What is claimed is:

1. A low calorie fat comprising a medium chain hydrocarbon esterified to a saturated long chain hydrocarbon to form a wax ester.

2. The low calorie fat according to claim 1, wherein said medium chain hydrocarbon is a medium chain fatty acid.

3. The low calorie fat according to claim 2, wherein said medium chain fatty acid is selected from the group consisting of caprylic acid and lauric acid,

4. The low calorie fat according to claim 1, wherein said saturated long chain hydrocarbon is a long chain fatty alcohol.

5. The low calorie fat according to claim 4, wherein said long chain fatty alcohol is arachidyl alcohol.

6. The low calorie fat according to claim 1, wherein said low calorie fat has a caloric value of less than about 6 kilocalories per gram.

7. The low calorie fat according to claim 1, wherein said low calorie fat has a caloric value of less than about 5.7 kilocalories per gram.

8. The low calorie fat according to claim 1, wherein said low calorie fat has a caloric value of less than about 5.2 kilocalories per gram.

9. The low calorie fat according to claim 1, wherein said low calorie fat has a caloric value of less than about 4.7 kilocalories per gram.

10. A fat ingredient having the formula (V): 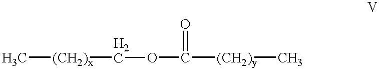
wherein x is greater than 14 and y is 0 to 10.

11. The fat ingredient according to claim 10, wherein x is 14 to 26.

12. The fat ingredient according to claim 10, wherein x is 14 to 24.

13. The fat ingredient according to claim 10, wherein x is 18.

14. The fat ingredient according to claim 10, wherein said fat ingredient has a caloric value of less than about 6 kilocalories per gram.

15. The fat ingredient according to claim 10, wherein said fat ingredient has a caloric value of less than about 5.7 kilocalories per gram.

16. The fat ingredient according to claim 10, wherein said fat ingredient has a caloric value of less than about 5.2 kilocalories per gram.

17. The fat ingredient according to claim 10, wherein said fat ingredient has a caloric value of less than about 4.7 kilocalories per gram.

18. A food composition comprising fat ingredients and nonfat ingredients, wherein at least a portion of the fat ingredients comprise the fat ingredient of claim 10.

19. A fat ingredient having the formula (VI): 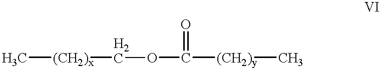
wherein m is greater than 14 and n is 0 to 10.

20. The fat ingredient according to claim 19, wherein m is 14 to 26.

21. The fat ingredient according to claim 19, wherein m is 14 to 24.

22. The fat ingredient according to claim 19, wherein m is 18.

23. The fat ingredient according to claim 19, wherein said fat ingredient has a caloric value of less than about 6 kilocalories per gram.

24. The fat ingredient according to claim 19, wherein said fat ingredient has a caloric value of less than about 5.7 kilocalories per gram.

25. The fat ingredient according to claim 19, wherein said fat ingredient has a caloric value of less than about 5.2 kilocalories per gram.

26. The fat ingredient according to claim 19, wherein said fat ingredient has a caloric value of less than about 4.7 kilocalories per gram.

27. A food composition comprising fat ingredients and nonfat ingredients, wherein at least a portion of the fat ingredients comprise the fat ingredient of claim 19.

28. A low calorie fat containing food composition, which comprises
(a) non-fat ingredients; and
(b) fat ingredients,
(c) wherein said fat ingredients comprise from about 5 to 95% by weight of said fat ingredients of claims 10 and 19.
